(19) United States
(12) Patent Application Publication
(10) Pub. No.: US 2015/0315730 A1
(43) Pub. Date: Nov. 5, 2015

(54) LINE FOR ANCHORING A HUNTING DECOY

(71) Applicant: Cortland Line Co., Cortland, NY (US)

(72) Inventor: Steven Toddes, Cortland, NY (US)

(73) Assignee: Cortland Line Co., Cortland, NY (US)

(21) Appl. No.: 14/269,620

(22) Filed: May 5, 2014

(51) Int. Cl. D04C 1/12; D07B 7/14; D07B 5/00; A01M 31/06; D07B 1/16

(52) U.S. Cl. CPC D04C 1/12; A01M 31/06; D07B 1/165; D07B 5/005; D07B 7/14

(57) ABSTRACT

In accordance with one embodiment, a line (cord) for use with a hunting decoy. The line includes a core formed of a first material and an outer jacket disposed around the core. The outer jacket is formed of a material that comprises plastisol and at least one metal.

### TECHNICAL FIELD

The present invention is directed to the field of hunting and more particularly, to an improved line (cord) for a floating decoy, such as a duck decoy, for securing the decoy to a desired area.

### BACKGROUND

Decoys are commonly used in different hunting sports to attract real animals, such a waterfowl, etc. More specifically, one hunting sport in which decoys are commonly used is duck hunting. Duck decoys are widely used as one means, typically used in conjunction with a call to attract real ducks to the vicinity of a duck blind or other camouflaged hunter hangout.

Frequently, weather conditions involve wind which can propel the decoy across the body of water to places displaced from the duck blind. In such situation, the decoy then becomes counterproductive, actually luring the duck away from the hunter. In order to combat this phenomena and prevent decoy migration, the decoy is usually tethered to an anchor which rests on the floor of the body of water. Traditionally, duck decoy lines are made of cords made of fibers and they include a tar outer surface. The tarred cord has a dark color, such as black, and is a little stiff and tacky from the treatment. The tar is applied to increase the durability and in particular, to prevent the core from rotting due to it being submerged in water for extended periods of time. In use, the tarred cord is tied in a knot to attach it to both the duck decoy and the anchor.

Unfortunately, these type of anchors and tethers are ineffective and often, the tethers develop slack and at least partially float, thereby scaring the duck.

### SUMMARY

In accordance with one embodiment, a line (cord) for use with a hunting decoy. The line includes a core formed of a first material and an outer jacket disposed around the core. The outer jacket is formed of a material that comprises plastisol and at least one metal.

### BRIEF DESCRIPTION OF THE DRAWING FIGURES

FIG. 1 is a side perspective view of a conventional decoy being tethered to a decoy line for attachment to an anchor and being shown in a position in which the decoy line is floating;

FIG. 2 is a side perspective view of a decoy line in accordance with the present invention being shown in use fully submerged;

FIG. 3 is a cross-sectional view of the decoy line of FIG. 2; and

FIG. 4 is side cross-sectional view of a decoy line according to the present invention showing a knotless loop for attaching the anchor to the decoy line.

### DETAILED DESCRIPTION OF CERTAIN EMBODIMENTS

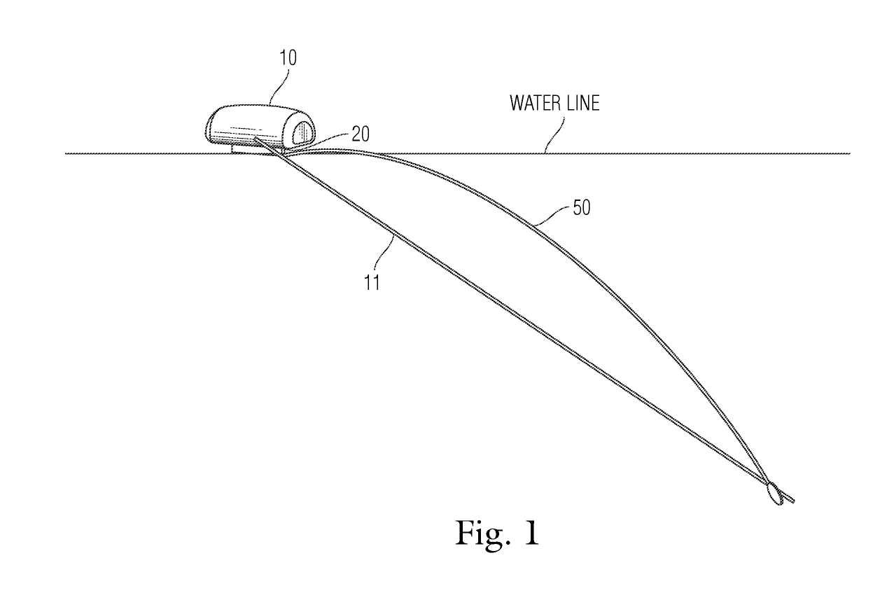

FIG. 1 is side perspective view of a decoy 10, such as a duck decoy. The decoy 10 can be formed of any number of conventional materials, including but not limited to wood, plastics, etc. The decoy 10 is shown in the figures generically and it will be appreciated that the decoy 10 typically has a form and size that mirrors a real duck, The decoy 10 will thus have a duck appearance and is preferably painted in colors and patterns to resemble a duck.

The decoy 10 will thus have a connector 20 that serves as an attachment point for attaching a conventional decoy line 50 to the decoy 10. The connector 20 should be at a location that preferably hides the line 50 when in use. For example, the connector 20 can be located along a bottom surface of the decoy 10 and thus, the decoy line 50 enters the water underneath the decoy 10 so as to not be visible to the real ducks.

While not shown in the drawings, the anchor is designed to sink to the bottom of the body of water, e.g., a lake or pond, and serves to hold the decoy 10 in a desired location (near the hunter). The anchor thus is formed of a heavy material, such as a metal, that will immediately sink to the bottom of the body of water. The anchor includes some type of connector to allow attachment between the distal end of the decoy line 50 and the anchor. Line 11 is a linear reference line from the decoy 10 to the anchor.

FIG. 1 shows the conventional decoy line 50 in use in the water and as discussed previously, the conventional line 50 suffers from the disadvantage that it is close to the water surface and a portion is exposed along the water's surface. In other words and as mentioned above, many conventional decoy lines 50 at least partially float during use, thereby scaring the real ducks away. The decoy line 50 can be thought to have a convex shape in this orientation.

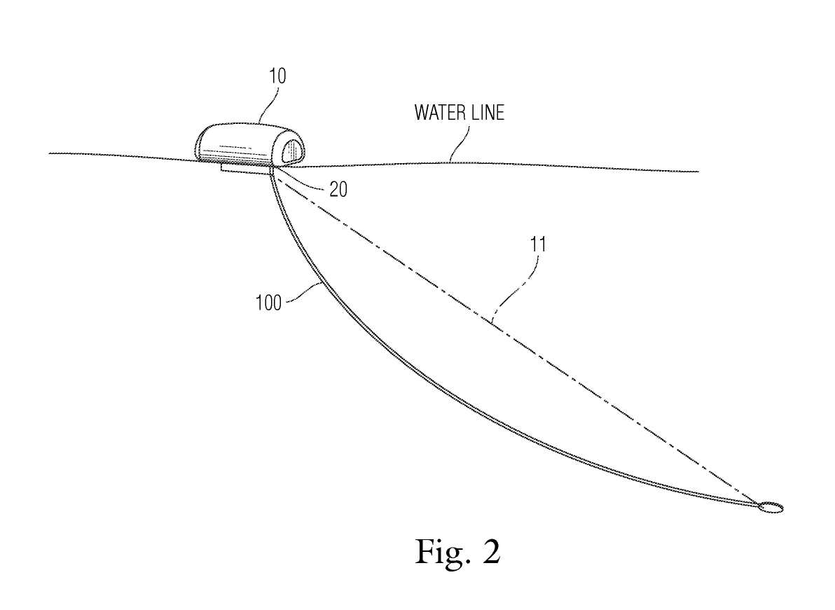

FIG. 2 shows a decoy line 100 in accordance with the present invention in use and being entirely submerged beneath the surface of the water.

In accordance with the present invention, the decoy line 100 is constructed such that during use, as shown in FIG. 2, the decoy line 100 remains submerged. In this orientation, the decoy line 100 assumes what can be thought of as a concave shape, whereby the decoy line 100 remains submerged under the water out of the sight of the real ducks.

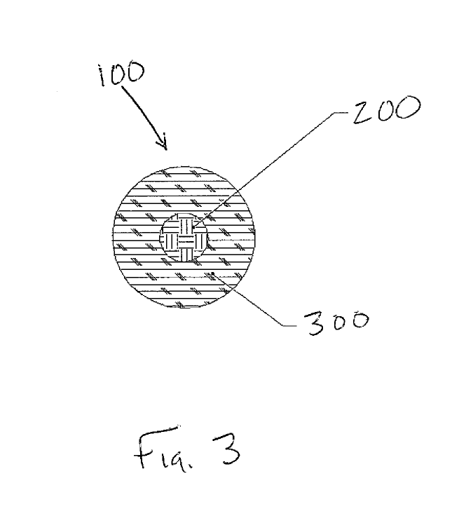

FIG. 3 is a cross-sectional view of the decoy line 100 showing its construction. More specifically, the decoy line 100 is formed of a first part 200 and a second part 300. The first part 200 comprises a central core of the line 100, while the second part 300 comprises a sheath or jacket that surrounds the first 200.

In accordance with the present invention, the decoy line 100 is manufactured using a pultrusion process. In a standard pultrusion process, a reinforcement material, such as a fiber, is impregnated with a resin and is pulled through a heated stationary die, where the resin undergoes polymerization. The impregnation is either typically done by pulling the reinforcement through a bath or by injection of the resin into an injection chamber which typically is connected to the die. Many resin types can be used in pultrusion including polyester, polyurethane, epoxy, etc. In the present invention, the first part 200 represents the core of the decoy line 200 that is fed through a bath or the like that is part of a pultrusion system to coat the first part 200 and form the outermost sheath/jacket 300.

The first part 200 that forms the core of the decoy line can be in the form of any number of different types of cords includes braided cores. The core 200 can thus be formed of any suitable type of filaments including natural filaments, such as jute; synthetic filament, such as nylon, Dacron, Vectran, etc.; or inorganic filaments, such as glass or carbon filaments. In one embodiment, the core 200 is formed of a braided nylon.

In accordance with the present invention, the outer jacket 300 is formed as a plastisol based composition. As is known, plastisol is a suspension of PVC particles in a liquid plasticizer which flows as a liquid and can be poured into a heated mold. Once the material is heated to a first threshold temperature (e.g., around 177° C.), the plastic and plasticizer mutually dissolve each other. On cooling the mold below a second threshold temperature (e.g., around 60° C.), a flexible, permanently plasticized solid product results. As used herein, the term “PVC plastisol” simply refers to plastisol that has suspended PVC particles.

The outer jacket 300 is formed of other ingredients besides plastisol and more specifically, the composition of the outer jacket 300 includes one or more metals mixed with the plastisol. For example, the composition of the outer jacket 300 can comprise: PVC plastisol; fillers; metals; and fibrous binders. For example, the PVC plastisol can be present in an amount between about 75% to 94% by weight; the fillers can be present in an amount between about 0% to 10% by weight; the metals can be present in an amount between about 5% to 10%; and the fibrous binders can be present in an amount between 1% to about 5%. Preferably, the metals have a particle size that is below 100 micron. Suitable metals include copper, tungsten and zinc.

In one exemplary embodiment, the composition that forms the outer jacket 300 has the following formula (by weight %): about 85% PVC plastisol; about 3% crushed glass; about 2% talc; about 8% copper and about 2% tungsten.

In one embodiment, the cured product (formed jacket 300) has a target density between about 1.4 g/cc and about 3.7 g/cc.

In addition, an exemplary diameter of the core (first part 200) can be between about 0.02 to about 0.05 inch, while an exemplary diameter of the outer jacket (second part 300) can be between about 0.04 to about 0.125 inch. In the illustrated embodiment, the core 200 has a diameter of about 0.03 inch and the outer jacket 300 has a diameter of about 0.07 inch.

The decoy line 100 is manufactured by performing the following steps: first, the core 200 is selected and composition that forms the outer jacket 300 is formulated and prepared. More specifically, the plastisol is mixed with the other ingredients, including the one or more metals, to form the liquid, flowable plastisol based composition. Next, the core 200 is drawn through the wet plastisol based composition at room temperature resulting in the plastisol based composition collecting along the core 200. The combined core and plastisol based composition is then drawn through a size die which in effect meters the plastisol based composition such that it has a selected size (diameter). In this step, the plastisol based composition is wet. The core 200 coated with the plastisol based composition (jacket 300) is then delivered to a heater, such as an oven, for heating the decoy line 100 to a first predetermined temperature. As mentioned above, this predetermined temperature is the first the material is the first threshold temperature at which the PVC and plasticizer mutually dissolve each other. After undergoing such heating, the decoy line 100 is then cooled (e.g., to the second threshold temperature) at which the outer jacket 300 is formed as a flexible, permanently plasticized solid structure.

The PVC based plastisol provides substantial body to the line and this results in the decoy line 100 having measurable strength and stiffness. The metal(s) are those that are suitable for the present use with plastisol to form the outer jacket 300 and thus, the metals form bonds with the plastisol and the metals also are non or slow oxidizing materials. The one or more metals that are used serve to add some weight to the decoy line 100 to cause submersion thereof. The material characteristics of the core 200 allows for knotting of the decoy line 100 (e.g., the braided nylon core with overlying jacket can be easily knotted).

The decoy line 100 of the present invention thus overcomes a number of the deficiencies of the prior art in that the decoy line 100 is robust and is weighted to cause the decoy line 100 to sink and remain submerged during use. At the same time, the decoy line 100 can be easily coupled to an object, such as the decoy 10 and the anchor as by being knotted.

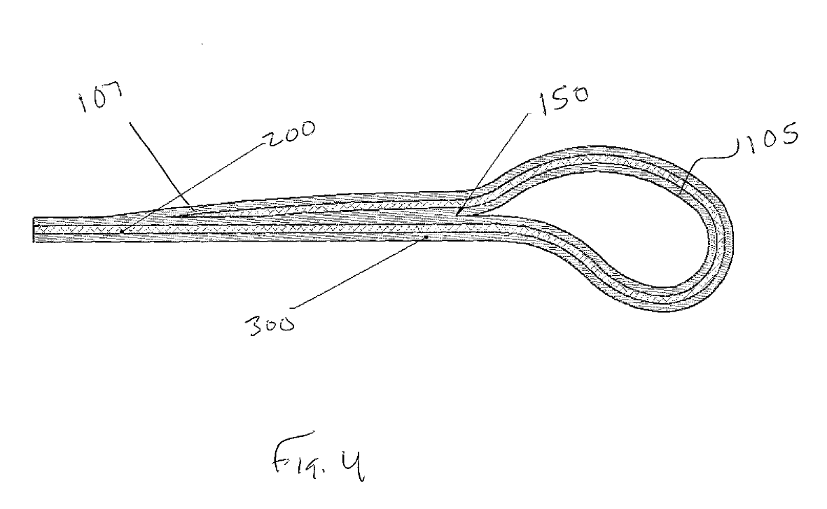

FIG. 4 shows another aspect/feature of the decoy line of the present invention in that the decoy line 100 can be a formed to have a knotless/crimpless loop for attaching the decoy line 100 to an object, such as the decoy 10 or the anchor. One of the difficulties encountered when using a crimp is that the organic matter, such as weeds and vegetation, get caught in the crimp.

The composition of the outer jacket 300 has a low glass transition temperature and therefore is conducive to melting when heat is applied; however, the makeup of the composition permits the outer jacket 300 to fuse to itself at point 150, while the core 200 holds the shape of the decoy line 100. Referring to FIG. 4, the decoy line 100 has an end loop 105 formed at one or both ends of the decoy line 100. The loop 105 is formed by looping one end 107 of the decoy line 100 back on top of itself to form the loop 105 and then heat is applied to the looped material. The applied heat causes a bonding to occur between the looped outer jacket 300. In other words, the end 107 is fused to another section of the decoy line 100, thereby forming the loop 105.

Conventional coated decoy lines cannot be manipulated in the above manner (i.e., bonded to itself by application of heat) due to the differences in the material compositions of the outer jacket. In particular, in the case of using a conventional PVC line, the heating of such line results in the material degrading and breaking apart. Unlike the prior art, the composition of the outer jacket 300 is such that a secure fusing/bonding occurs as opposed to material degradation of the line as in the prior art.

To attach the decoy line 100 to an object, such as the decoy 10 or the anchor, the end 107 is passed through the respective connector of the object and then the end 107 is folded back so that the end 107 is positioned in intimate contact with another section of the outer jacket 300. Heat from a suitable source, such as a hair dryer or cigarette lighter, is applied causing the end 107 to melt and bond to the outer jacket 300. This construction thus allows the end user to easily form the knotless/crimpless loop.

In another embodiment, this process is facilitated with the use of a PVC tubing which helps hold the material (jacket 300) in place as it melts and cures.

While the invention has been described in connection with certain embodiments thereof, the invention is capable of being practiced in other forms and using other materials and structures. Accordingly, the invention is defined by the recitations in the claims appended hereto and equivalents thereof.

What is claimed is:

1. A line for use with a hunting decoy comprising:
a core formed of a first material; and
an outer jacket disposed around the core, the outer jacket is formed of a material that comprises plastisol and at least one metal.

2. The line of claim 1, wherein the core comprises a plurality of filaments.

3. The line of claim 2, wherein the filaments are selected from the group consisting of: natural filaments; synthetic filaments; and inorganic filaments.

4. The line of claim 1, wherein the core comprises a braided structure.

5. The line of claim 4, wherein the core comprises braided nylon.

6. The line of claim 1, wherein the plastisol comprises a suspension of PVC particles in a liquid plasticizer and the at least one metal comprises two or more metals.

7. The line of claim 1, wherein the plastisol is present in an amount between about 75% to 94% by weight and the at least one metal is present in an amount between about 5% to 10% by weight.

8. The line of claim 7, wherein the at least one metal comprises two or more metals.

9. The line of claim 6, wherein the material of the outer jacket further comprises filters and fibrous binders.

10. The line of claim 1, wherein the material that forms the outer jacket has the following formula (by weight %): about 85% PVC plastisol; about 3% crushed glass; about 2% talc; about 8% copper and about 2% tungsten.

11. The line of claim 1, wherein the at least one metal has a particle size that is below 100 micron.

12. The line of claim 1, wherein the material of the outer jacket allows a first end of the line to be bonded to another section of the line upon application of heat, whereby a loop is formed.

13. A method for making a decoy line formed of a core and outer jacket comprising the steps of:
preparing a plastisol based composition;
placing the plastisol based composition in a tank;
forming the outer jacket around the core by a pultrusion process.

14. The method of claim 13, wherein the plastisol based composition includes at least one metal and the core comprises a plurality of filaments.

15. The method of claim 14, wherein the core comprises a braided structure.

16. The method of claim 14, wherein the plastisol is present in an amount between about 75% to 94% by weight and the at least one metal is present in an amount between about 5% to 10% by weight.

17. The method of claim 13, wherein the plastisol based composition further comprises filters and fibrous binders.

18. The method of claim 13, wherein the material that forms the outer jacket has the following formula (by weight %): about 85% PVC plastisol; about 3% crushed glass; about 2% talc; about 8% copper and about 2% tungsten.

19. The method of claim 13, wherein the at least one metal has a particle size that is below 100 micron.

20. The method of claim 13, wherein the step of forming the outer jacket around the core by a pultrusion process comprises the steps of:
drawing the core through a tank containing the plastisol based composition and through a size die resulting in the cord being coated with the plastisol based composition;
heating the core coated with the plastisol based composition to a first temperature; and
cooling the core coated with the plastisol based composition to form the outer jacket around the core.
